(19) United States
(12) Patent Application Publication
(10) Pub. No.: US 2020/0254568 A1
(43) Pub. Date: Aug. 13, 2020

(54) METHOD AND DEVICE FOR ROUNDING OFF AN UNDESIRED BURR AND/OR UNDESIRED MATERIAL ACCUMULATED ON REAR EDGES OF SPOKES OF A VEHICLE LIGHT-ALLOY WHEEL DURING ITS MANUFACTURE

(71) Applicant: Superior Industries Production Germany GmbH, Bad Duerkheim (DE)

(72) Inventor: Andreas SCHOLLMEIER, Overath (DE)

(73) Assignee: Superior Industries Production Germany GmbH, Bad Duerkheim (DE)

(21) Appl. No.: 16/649,538

(22) PCT Filed: Feb. 21, 2019
(86) PCT No.: PCT/EP2019/000055

§ 371 Date: Mar. 20, 2020

(30) Foreign Application Priority Data
Feb. 22, 2018 (DE) 10 2018 001 396.1

(51) Int. Cl. B23K 26/354; B23K 26/361; B60B 1/04

(52) U.S. Cl. CPC B23K 26/354; B23K 2103/10; B60B 1/043; B23K 26/361

(57) ABSTRACT

A method for rounding off an undesired burr and/or material accumulated on vehicle spoke rear edges, in particular light-alloy automotive wheel during manufacture, the burr having been produced or the material having accumulated during a preceding mechanical processing step of the light-alloy wheel, rounds off the burr or the accumulated material by laser beam remelting. The rounding off is achieved by orienting the light-alloy wheel during the lasering such that the rear edge of the respective spoke being lasered points downwards and by, as a result of laser beam energy applied, the light alloy of the spoke is melted locally, partially and directly from above, i.e. on a front spoke edge, and/or laterally from above so that the resulting molten material flows downwards by gravity, hardens on the spoke rear face as a rounded portion and thereby rounds off the undesired burr or the undesired material accumulated there.

The present invention relates to a method in accordance with the preamble of claim 1, as well as to an apparatus for carrying out such a method.

A light-metal wheel for a vehicle, provided with spokes, for example an aluminum wheel for a passenger car, passed through multiple different processing steps or processing stations during the course of its production process. This includes, among other things, also chip-cutting mechanical processing such as lathing on a lathing machine provided with a lathe tool. In order to ensure certain mechanical properties as well as paintability of the said light-metal wheel after mechanical processing, the rear spoke flanks, i.e. those spoke flanks that are not visible to an observer in the case of the light-metal wheel that is ultimately mounted on the vehicle as intended, must be deburred or rounded off. This is because light-metal wheels, in particular aluminum wheels, have the property of having a sharp-edged burr on the rear edges of their spokes, as a result of the first mechanical processing steps during their production. This burr, as mentioned above, then builds up extremely during the further mechanical processing of the light-metal wheel, which is chip-cutting mechanical processing—for example by means of a lathe tool—in particular on the run-out side of the lathe tool—and can then actually be referred to more as a material accumulation than as a burr. This burr or this material accumulation is undesired to a very high degree, because it reduces the mechanical quality of the light-metal wheel and hinders paintability of the light-metal wheel to a significant extent. For this reason, this burr or this accumulation that has formed on the rear spoke flanks must absolutely be deburred or rounded off. As a result, the notch effect is supposed to be minimized, and—in view of painting of the spokes that follows during the course of the production process of the light-metal wheel—buildup of a correspondingly sufficient paint layer thickness in the edge region is supposed to be ensured, so as to prevent edge corrosion.

In the state of the art, machines called brush deburring machines are used for automated removal of the aforementioned undesired burr or the aforementioned undesired material accumulation. However, these brush deburring machines are not able to reliably achieve the desired result, in terms of process. They merely achieve a partial result—and do so only by means of great material expenditure—which requires manual reworking in any case. This is because the brush of the brush deburring machine from the state of the art cannot reach every region of the spokes of the light-metal wheel, so that rounding does not occur in certain regions, in the end result of processing, and these regions must subsequently be treated manually, at great labor effort.

The invention is therefore based on the task of making available a method for rounding off an undesired burr and/or an undesired material accumulation on rear edges of spokes of a light-metal wheel for a vehicle during the process of its production, which method is more reliable, in terms of process, than how the rounding off by means of a brush deburring machine known from the state of the art can be carried out, and makes corresponding manual rework of the spokes of the light-metal wheel unnecessary or at least reduces it to a significant degree as compared with the state of the art. The invention is furthermore based on the task of making available an apparatus for carrying out this novel method.

According to the invention, these tasks are accomplished by means of a method according to claim 1 and by means of an apparatus according to claim 11. Advantageous and preferred further development of the method according to the invention, according to claim 1, are the object of claims 2 to 10.

Exemplary embodiments of the invention will be explained below. No figures are required for this, since the present invention easily becomes clear to a person skilled in the art even without a representation in figures, simply on the basis of the text.

The method according to the invention is a method for rounding off an undesired burr and/or an undesired material accumulation on rear edges of spokes of a light-metal wheel for a vehicle during the process of its production, in particular a motor vehicle. How this undesired burr or this undesired material accumulation comes about, as well as the question why this burr or this material accumulation is undesired was already explained and discussed above. The term rear edge of a spoke refers to that edge of the spoke of the light-metal wheel that is not visible to an observer when the light-metal wheel is installed on a vehicle as intended. In contrast, the term front edge of a spoke refers to that edge of the spoke of the light-metal wheel that is visible to the observer when the light-metal wheel is installed on a vehicle as intended.

The stated light-metal wheel can be an aluminum wheel or a magnesium wheel, for example, or the light-metal wheel can consist of an alloy containing aluminum or an alloy containing magnesium, for example. However, it can also be any other light-metal wheel that has spokes.

In the method according to the invention, in every case the said burr or the said material accumulation is rounded off by means of a laser re-melting method, using a laser beam generated by a laser. This rounding off is achieved, in the case of the method according to the invention, in that during laser application, the light-metal wheel is oriented in such a manner that the rear edge of the spoke to which the laser is applied, in each instance, is directed downward, and that the light metal is melted on the aforementioned spoke, partially and directly from above, in other words at a front edge of this aforementioned spoke, and/or laterally from above, so that the melt that occurs during this process flows away downward due to the effect of gravity, hardens in the form of a rounding on the rear of the spoke, and in this manner rounds off the undesired burr or the undesired material accumulation that is present there.

Preferably, the respective edge in question has inert gas applied to it during the entire process of melting and hardening, so as to prevent contamination of the light metal and to continue to ensure a uniform metal grade and quality.

Directing the rounding to the underside of the spoke, in other words to the rear edge of the spoke, takes place, in the case of the method according to the invention, solely by means of the physically existing weight force, since the laser procedure is carried out from above, and the metal melt can flow to the underside of the spoke.

In order to ensure that within the scope of the method according to the invention, a laser having sufficient power can be used in gentle manner, preferably a rigid laser is used to carry out the method according to the invention, and the light-metal wheel is moved past the fixed laser source accordingly, by means of a three-dimensional manipulator, for example by means of a robot having a gripper, wherein in most exemplary embodiments of the method according to the invention, the three-dimensional manipulator holds the light-metal wheel firmly clamped during this movement as stated above. In order to generate and control the movement paths of the three-dimensional manipulator required for this, the light-metal wheel is preferably first measured in three dimensions by means of a corresponding, suitably configured measurement device, wherein all the spoke edges of the light-metal wheel are identified with reference to the three-dimensional manipulator or with reference to the robot gripper, so that the work step described above, that of moving the light-metal wheel past the fixed laser source, can be carried out in automated manner.

Accordingly, an exemplary embodiment of the method according to the invention proceeds as follows, very preferably in completely automated manner:
a) gripping the light-metal wheel by means of the three-dimensional manipulator, for example by means of a robot gripper,
b) bringing the light-metal wheel to the said measurement device by means of the three-dimensional manipulator,
c) automated three-dimensional measuring of the light-metal wheel in its spoke region by means of the said measurement device, wherein the light-metal wheel is firmly held by the three-dimensional manipulator during this measurement procedure, in such a manner that absolutely fixed positioning of the spokes of the light-metal wheel with reference to the manipulator foot point (also called TCP; TCP—Tool Center Point), for example with reference to the robot TCP, is ensured,
d) on the basis of the measurement values obtained in step c), automated calculation of the required laser paths along the spokes of the metal wheel, and thereby of the corresponding required movement paths of the three-dimensional manipulator, and supply of the corresponding calculation results to a control device of the three-dimensional manipulator for the purpose of corresponding subsequent control of the movement of the three-dimensional manipulator with reference to the fixed laser head,
e) moving the light-metal wheel by means of the three-dimensional manipulator, for example by means of the robot, along the fixed laser head, wherein the spokes of the light-metal wheel are impacted by the laser from above, so that the melt can flow downward due to the effect of gravity, and can harden again at the rear of the spoke, wherein the respective melted spoke region has inert gas applied to it, and
f) subsequently, laying the light-metal wheel down by means of the three-dimensional manipulator, for the purpose of being conveyed to a next station in the production process of the light-metal wheel.

An exemplary embodiment of an apparatus according to the invention, for carrying out the exemplary embodiment of the method according to the invention as described in the preceding paragraph, has the following:
the fixed laser, which can be a fiber laser or a CO₂ laser, for example, having the fixed laser head,
the automated three-dimensional manipulator, which can be a robot having a gripper, for example,
the control device for controlling the movement of the three-dimensional manipulator,
the measurement device for automated three-dimensional measurement of the light-metal wheel in the spoke region of the light-metal wheel,
a data processing device for automated calculation of the required laser paths along the spokes of the metal wheel, and thereby the corresponding required movement paths of the three-dimensional manipulator, and
a device for supplying the corresponding calculation results of the data processing device to the said control device of the three-dimensional manipulator, for the purpose of corresponding subsequent control of the movement of the three-dimensional manipulator with reference to the fixed laser head.

In this regard, the fixed laser having the fixed laser head, the automated three-dimensional manipulator, the control device for controlling the three-dimensional manipulator, the said measurement device, the said data processing device, and the device for supplying the calculation results of the data processing device to the control device for controlling the three-dimensional manipulator are set up and coordinated with one another in such a manner that the exemplary embodiment of the apparatus according to the invention, described here, is able to carry out the exemplary embodiment of the method according to the invention stated and described above.

1. A method for rounding off an undesired burr and/or an undesired material accumulation on rear edges of spokes of a light-metal wheel for a vehicle during the process of its production, in particular for a motor vehicle, wherein the said burr or the said material accumulation has built up during the course of preceding mechanical processing of the light-metal wheel during the course of its production process, wherein the said burr or the said material accumulation is rounded off by means of a laser re-melting method, using a laser beam generated by a laser, wherein the rounding off is achieved in that during laser application the light-metal wheel is oriented in such a manner that the rear edge of the spoke to which the laser is applied, in each instance, is directed downward, and that the light metal is melted on the aforementioned spoke, partially and directly from above, in other words at a front edge of this aforementioned spoke, by means of the laser beam energy input, and/or laterally from above, so that the melt that occurs during this process flows away downward due to the effect of gravity, hardens in the form of a rounding on the rear of the spoke, and in this manner rounds off the undesired burr or the undesired material accumulation that is present there.

2. The method according to claim 1, wherein the light-metal wheel comprises aluminum and/or magnesium and/or an alloy containing aluminum and/or of an alloy containing magnesium.

3. The method according to claim 1, wherein the respective edge in question has inert gas applied to it during the entire process of melting and hardening, so as to prevent contamination of the light metal.

4. The method according to claim 1, wherein the laser is a fixed laser having a fixed laser head, and that wherein the light-metal wheel is moved past the fixed laser head for the purpose of carrying out targeted laser re-melting.

5. The method according to claim 4, wherein the said movement of the light-metal wheel takes place by means of an automated three-dimensional manipulator, for example by means of a robot gripper.

6. The method according to claim 5, wherein the automated manipulator holds the light-metal wheel firmly clamped in place during the said movement.

7. The method according to claim 5, wherein before the start of re-melting, the light-metal wheel is measured in three dimensions in its spoke region by means of a measurement device, in automated manner, and on the basis of measurement values obtained during this measurement procedure the required laser paths along the spokes of the light-metal wheel, and thereby the corresponding required movement paths of the three-dimensional manipulator, are calculated in automated manner, and the corresponding calculation results are supplied to a control device of the three-dimensional manipulator, for the purpose of subsequent control of the movement of the three-dimensional manipulator with reference to the fixed laser head.

8. The method according to claim 7, wherein the three-dimensional manipulator, which can be a robot for example, grips the light-metal wheel before the start of the said measurement procedure and holds the light-metal wheel firmly during the said measurement procedure, in such a manner that ii during this regard, process absolutely fixed positioning of the spokes of the light-metal wheel with reference to the manipulator foot point (also called TCP; TCP—Tool Center Point), for example with reference to the robot TCP, is ensured.

9. The method according to claim 1, wherein it proceeds entirely or at least partially in automated manner.

10. The method according to claim 8, having the following steps:
a) gripping the light-metal wheel by means of the three-dimensional manipulator, for example by means of a robot gripper,
b) bringing the light-metal wheel to the said measurement device by means of the three-dimensional manipulator,
c) automated three-dimensional measuring of the light-metal wheel in its spoke region by means of the said measurement device, wherein the light-metal wheel is firmly held by the three-dimensional manipulator during this measurement procedure, in such a manner that during this process absolutely fixed positioning of the spokes of the light-metal wheel with reference to the manipulator TCP, for example with reference to the robot TCP, is ensured,
d) on the basis of the measurement values obtained in step c), automated calculation of the required laser paths along the spokes of the light-metal wheel, and thereby of the corresponding required movement paths of the three-dimensional manipulator, and supply of the corresponding calculation results to a control device of the three-dimensional manipulator for the purpose of corresponding subsequent control of the movement of the three-dimensional manipulator with reference to the fixed laser head,
e) moving the light-metal wheel by means of the three-dimensional manipulator, for example by means of the robot, along the fixed laser head, wherein the spokes of the light-metal wheel are impacted by the laser from above, so that the melt can flow downward due to the effect of gravity, and can harden again at the rear of the spoke, wherein the respective melted spoke region has inert gas applied to it, and
f) subsequently, laying the light-metal wheel down by means of the three-dimensional manipulator, for the purpose of being conveyed to a next station in the production process of the light-metal wheel.

11. An apparatus for carrying out the method according to claim 7, wherein the apparatus has
the fixed laser, which can be a fiber laser or a CO2 laser, for example, having the fixed laser head,
the automated three-dimensional manipulator, which can be a robot having a gripper, for example,
the control device for controlling the movement of the three-dimensional manipulator,
the measurement device for automated three-dimensional measuring of the light-metal wheel in the spoke region of the light-metal wheel,
a data processing device for automated calculation of the required laser paths along the spokes of the light-metal wheel, and thereby the corresponding required movement paths of the three-dimensional manipulator, and
a device for supplying the corresponding calculation results of the data processing device to the said control device of the three-dimensional manipulator, for the purpose of corresponding subsequent control of the movement of the three-dimensional manipulator with reference to the fixed laser head,
wherein
the fixed laser having the fixed laser head, the automated three-dimensional manipulator, the control device for controlling the three-dimensional manipulator, the said measurement device, the said data processing device, and the device for supplying the calculation results of the data processing device to the control device for controlling the three-dimensional manipulator are set up and coordinated with one another in such a manner that the apparatus is able to carry out the said method.
